(19) United States
(12) Patent Application Publication
(10) Pub. No.: US 2008/0176546 A1
(43) Pub. Date: Jul. 24, 2008

(54) APPLICATION PROGRAMMING INTERFACE (API) FOR A RECEIVER IN A WIRELESS COMMUNICATIONS DEVICE

(75) Inventors: Michael Devico, San Diego, CA (US); Phani Bhushan Avadhanam, San Diego, CA (US); Rob Stacey, San Diego, CA (US); Shusheel Gautam, San Diego, CA (US); Tong Tang, San Diego, CA (US); Viktor Filiba, San Diego, CA (US); Ying Gao, San Diego, CA (US); Jian Zhang, San Diego, CA (US); Paul Richard Ellis, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/828,167

(22) Filed: Jul. 25, 2007

Related U.S. Application Data
(60) Provisional application No. 60/886,293, filed on Jan. 23, 2007.

(51) Int. Cl. H04M 3/00; H04Q 7/20

(52) U.S. Cl. 455/418; 455/436

(57) ABSTRACT

An apparatus is configured to receive a signal in accordance with a protocol stack comprising a physical layer, MAC layer, control layer and stream layer. The apparatus includes a receiver stack processing system configured to provide the control and stream layers, a media processing system configured to provide the physical and MAC layers, and an application programming interface (API) to support service requests from the receiver stack processing system to the media processing system.

### CLAIM OF PRIORITY UNDER 35 U.S.C. §119

The present Application for Patent claims priority to Provisional Application No. 60/886,293 entitled “APPLICATION PROGRAMMING INTERFACE (API) FOR RECEIVER IN A WIRELESS COMMUNICATIONS DEVICE” filed Jan. 23, 2007, and assigned to the assignee hereof and hereby expressly incorporated by reference herein.

### BACKGROUND

1. Field

The present disclosure relates generally to communication systems and methods, and more particularly, to an application programming interface (API) for a receiver in a wireless communications device.

2. Background

Forward Link Only (FLO) is a digital wireless technology that has been developed by an industry-led group of wireless providers. FLO technology uses advances in coding and interleaving to achieve high-quality reception, both for real-time content streaming and other data services. FLO technology can provide robust mobile performance and high capacity without compromising power consumption. The technology also reduces the network cost of delivering multimedia content by dramatically decreasing the number of transmitters needed to be deployed. In addition, FLO technology-based multimedia multicasting compliments wireless operators' cellular network data and voice services, delivering content to the same cellular mobile terminals used on 3G networks.

Today, FLO technology is used to create and broadcast real time multimedia content across various networks to a large number of mobile subscribers. These mobile subscribers generally employ a FLO receiver, which can be described conceptually with a reference model comprising a number of processing layers, typically referred to as a “protocol stack.” Each processing layer includes one or more entities that perform specific functions.

An attractive feature of the protocol stack employed by the FLO receiver is that each layer is self-contained so that the functions performed by one layer can be performed independently of the functions performed by the other layers. This allows improvements to be made to the FLO receiver for one layer without adversely affecting the other layers. However, various challenges are posed when designing the interface between layers in the FLO receiver. Efficient communications across layers in terms of efficient reception of multicast services is always an objective of the FLO receiver designer.

### SUMMARY

In accordance with one aspect of the disclosure, an apparatus is configured to receive a signal in accordance with a protocol stack comprising a physical layer, MAC layer, control layer and stream layer. The apparatus includes a receiver stack processing system configured to provide the control and stream layers, a media processing system configured to provide the physical and MAC layers, and an application programming interface (API) to support service requests from the receiver stack processing system.

In accordance with another aspect of the disclosure, an apparatus is configured to receive a signal in accordance with a protocol stack comprising a physical layer, MAC layer, control layer and stream layer. The apparatus includes first processing means for providing the control and stream layers, second processing means for providing the physical and MAC layers, and application programming interface (API) means for supporting service requests from the first processing means.

In accordance with a further aspect of the disclosure, a method of communications includes receiving a signal in accordance with a protocol stack comprising a physical layer, MAC layer, control layer and stream layer, the physical and MAC layers, the control and stream layers being implemented with a media processing system, and the control and stream layers being implement with a receiver stack processing system. The method further includes supporting service requests with an application programming interface (API), from the receiver stack processing system to the media processing system.

In accordance with yet a further aspect of the disclosure, a machine-readable medium includes instructions executable by one or more processors in an apparatus, the apparatus being configured to receive a signal in accordance with a protocol stack comprising a physical layer, MAC layer, control layer and stream layer, the control and stream layers being implemented with a media processing system, and the control and stream layers being implement with a receiver stack processing system. The instructions include a receiver stack code segment to implement the receiver stack processing system, and an application programming interface (API) code segment to support service requests from the receiver stack processing system to the media processing system.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a wireless communications system are illustrated by way of example, and not by way of limitation, in the accompanying drawings, wherein:

FIG. 1 is a conceptual diagram illustrating an example of a communications system;

FIG. 2 is a conceptual diagram illustrating an example of a protocol stack for a receiver;

FIG. 3 is a conceptual diagram illustrating various receiver blocks and their relationship to the protocol stack of FIG. 2;

FIG. 4 is a diagram illustrating an example of the call flow to turn on the receiver;

FIG. 5 is a diagram illustrating an example of the call flow to turn off the receiver;

FIG. 6 is a diagram illustrating an example of the call flow when a specific logical channel is requested by a receiver stack in the receiver;

FIG. 7 is a diagram illustrating an example of the call flow when a wireless device transitions from the coverage region of a network or infrastructure to another;

FIG. 8 is a diagram illustrating an example of the call flow when a receiver fails to meet the acquisition criteria;

FIG. 9 is a diagram illustrating an example of the call flow when the receiver detects an update in the control information in its cache;

FIG. 10 is a diagram illustrating an example of the call flow to monitor overhead information;

FIG. 11 is a diagram illustrating an example of the call flow of setting the frequency scan list for an ASIC specific software block in the receiver; and

FIG. 12 is a functional block diagram of an apparatus configured to receive a signal in accordance with a protocol stack.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the following detailed description, various concepts will be described in the context of a FLO technology. While these concepts may be well suited for this application, those skilled in the art will readily appreciate that these concepts are likewise applicable to other technology. Accordingly, any reference to FLO technology is intended only to illustrate these concepts, with the understanding the such concepts have a wide range of applications.

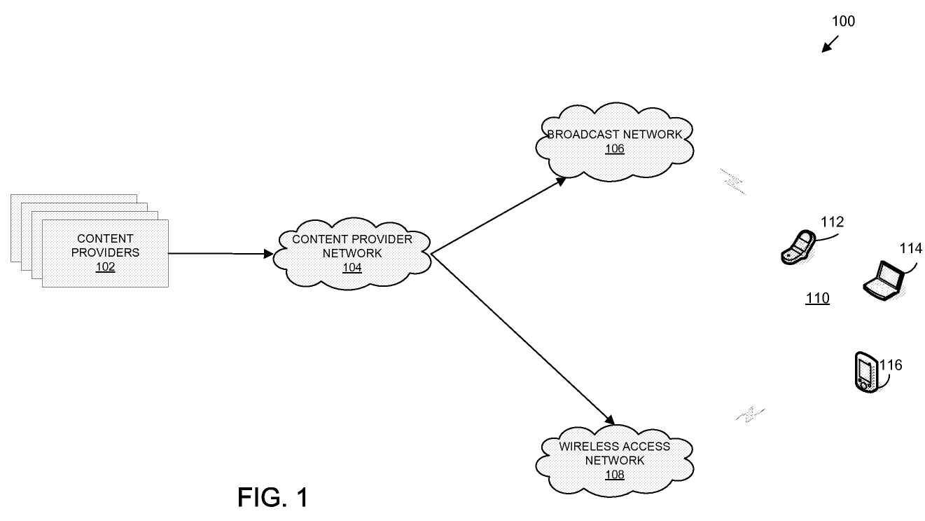

FIG. 1 shows a communications system 100 that creates and broadcasts multimedia content across various networks to a large number of mobile subscribers. The communications system 100 includes any number of content providers 102, a content provider network 104, a broadcast network 106, and a wireless access network 108. The communications system 100 is also shown with a number of devices 110 used by mobile subscribers to receive the multimedia content. These devices 110 include a mobile telephone 112, a personal digital assistance (PDA) 114, and a laptop computer 116. The devices 110 illustrate just some of the devices that are suitable for use in the communications system 100. It should be noted that although three devices are shown in FIG. 1, virtually any number of analogous devices, or types of devices are suitable for use in the communications system 100, as would be apparent to those skilled in the art.

The content providers 102 provide content for distribution to mobile subscribers in the communications system 100. The content may include video, audio, multimedia content, clips, real-time and non real-time content, scripts, programs, data or any other type of suitable content. The content providers 102 provide content to the content provider network 104 for wide-area or local-area distribution.

The content provider network 104 comprises any combination of wired and wireless networks that operate to distribute content for delivery to mobile subscribers. In the example illustrated in FIG. 1, the content provider network 104 distributes content through a broadcast network 106. The broadcast network 106 comprises any combination of wired and wireless proprietary networks that are designed to broadcast high quality content. These proprietary networks may be distributed throughout a large geographic region to provide seamless coverage to mobile devices. Typically, the geographic region will be divided into sectors with each sector providing access to wide-area and local-area content.

The content provider network 104 may also include a content server (not shown) for distribution of content through a wireless access network 108. The content server communicates with a base station controller (BSC) (not shown) in the wireless access network 108. The BSC may be used to manage and control any number of base transceiver stations (BTS)s (not shown) depending on the geographic reach of the wireless access network 108. The BTSs provide access to wide-area and local-area for the various devices 110.

The multimedia content broadcast by the content providers 102 include one or more services. A service is an aggregation of one or more independent data components. Each independent data component of a service is called a flow. By way of example, a cable news service may include three flows: a video flow, an audio flow, and a control flow.

Services are carried over one or more logical channels. In FLO applications, a logical channel is often referred to as a Multicast Logical Channel (MLC). A logical channel may be divided into multiple logical sub-channels. These logical sub-channels are called streams. Each flow is carried in a single stream. The content for a logical channel is transmitted through the various networks in a physical frame. In FLO applications, the physical frame is often referred to as a superframe.

The air interface used to transmit the physical frames to the various devices 110 shown in FIG. 1 may vary depending on the specific application and the overall design constraints. In general, communication systems employing FLO technology utilize Orthogonal Frequency Division Multiplexing (OFDM), which is also utilized by Digital Audio Broadcasting (DAB), Terrestrial Digital Video Broadcasting (DVB-T), and Terrestrial Integrated Services Digital Broadcasting (ISDB-T). OFDM is a multi-carrier modulation technique that effectively partitions the overall system bandwidth into multiple (N) sub-carriers. These sub-carriers, which are also referred to as tones, bins, frequency channels, etc., are spaced apart at precise frequencies to provide orthogonality. Content may be modulated onto the sub-carriers by adjusting each sub-carrier's phase, amplitude or both. Typically, quadrature phase shift keying (QPSK) or quadrature amplitude modulation (QAM) is used, but other modulation schemes may also be used.

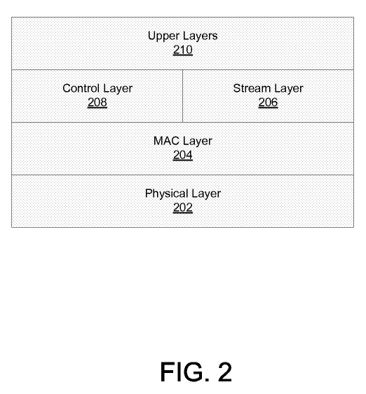

FIG. 2 is a conceptual diagram illustrating an example of a protocol stack 200 for the receiver used in one or more of the devices 110 shown in FIG. 1. The protocol stack, is shown with a physical layer 202, a Medium Access Control (MAC) layer 204, a stream layer 206, a control layer 208, and a number of upper layers 210. The upper layers 210 provide multiple functions including compression of multimedia content and controlling access to the multimedia content. The control layer 208 is used to process control information that facilitates the operation of the device in the communications system. The receiver also uses the control layer to maintain synchronization of its control information with that in the communications system. The stream layer 206 provides for binding of upper layer flows to streams. The stream layer is at the same level as the control layer in the protocol stack 200 of the receiver. The MAC layer 204 provides multiplexing of packets belonging to different media streams associated with the logical channels. The MAC layer 204 defines the procedures used to receive and transmit over the physical layer 202. The physical layer provides the channel structure, frequency, power output, modulation and encoding specification for the air interface.

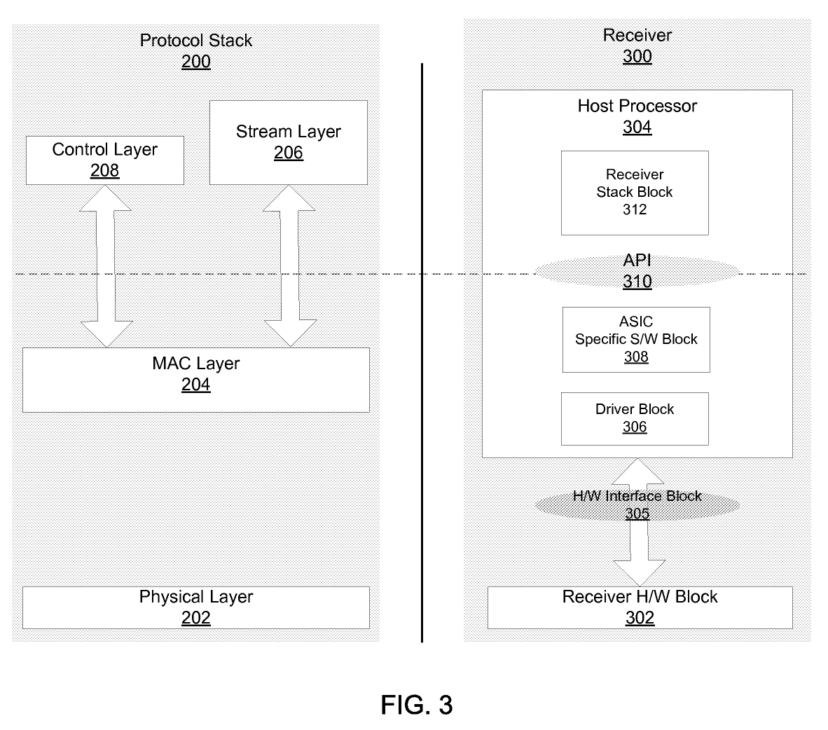

FIG. 3 is a conceptual diagram illustrating various receiver blocks and their relationship to the protocol stack of FIG. 2. In this example, the receiver 300 includes receiver hardware block 302, a host processor block 304, and a hardware interface block 305. The receiver hardware block 302 will be described as an application specific integrated circuit (ASIC), but may have different hardware implementations depending on the particular application and the overall design requirements. The host processor block 302 is shown with a driver block 306 (hardware specific abstraction layer), an ASIC specific software block 308, and a receiver stack block 312. An application program interface (API) 310 is used to interface the ASIC specific software block 308 to the receiver stack block 312.

The receiver blocks located below the API 310 will be collectively referred to as a media processing system. The media processing system provides the physical and MAC layer 202, 204 functionality of the protocol stack 200. The receiver stack block 312, located above the API 310, will be referred to as the receiver stack processing system, which provides the stream and control layer 206, 208 functionality of the protocol stack 200. The exact division of the protocol functionality in the media processing system or in the receiver stack processing system is implementation dependant. By way of example, the MAC layer 204 can be localized in the ASIC specific software block 308 for one implementation while for another implementation it may be spread across all blocks in the media processing system, namely the receiver hardware block 302, the driver block 306 and the ASIC specific software block 308.

The functionality of the receiver blocks will now be described. This description is informative in nature and broadly defines the functionality of each block. Only the pertinent functionality to various concepts described throughout this disclosure will be described. Those skilled in the art will recognize that these blocks can provide other functionality that is not described herein.

The receiver hardware block 302 represents the semiconductor hardware that provides the functionality of demodulating a wireless signal and retrieving data carried by the physical layer. This block 302 provides various functions such as RF front-end processing, ADC, timing and frequency estimation, channel estimation, turbo decoding etc. In summary, the receiver hardware block 302 provides the complete physical layer 202 implementation of the protocol stack. Depending upon the implementation, this block 302 may also provide full or partial MAC layer 204 functionality (e.g. low level MAC layer functionality like R-S decoding and/or MAC layer interleaving).

The host processor block 304 represents the functionality provided by a host processor in the receiver 300. More specifically, the host processor block 304 represents the host processor hardware and the software implementation residing in the host processor. The host processor hardware may be implemented with one or more processors, including by way of example, a general purpose processor, such as a microprocessor, and/or a specific application processor, such a digital signal processor (DSP). The host processor block 304 may also include a machine readable medium for storing software executed by the one or more processors. Software shall be construed broadly to mean any combination of instructions, data structures, or program code, whether referred to as software, firmware, middleware, microcode, or any other terminology. The machine readable medium may include one or more storage devices that are implemented, either in whole or part, by the host processor hardware. The machine readable medium may also include one or more storage devices remote to the host processor, a transmission line, or a carrier wave that encodes a data signal. Those skilled in the art will recognize how best to implement the described functionality for the host processor block 304 for each particular application.

The host processor block 304 communicates with the receiver hardware block 302 to retrieve and process information recovered from the wireless transmission. The retrieved information includes control information received on a control channel, content received on an overhead channel, and the application layer content carried in a logical channel.

The driver block 306 represents the driver level software in the host processor block 304 that directly interfaces with the receiver hardware block 302. The driver block 306 provides controller functions (e.g. turning on or turning off the receiver hardware block 302) and data exchange functions (e.g. retrieving the data from the receiver hardware block 302 or conveying the characteristics of a logical channel to be received). The driver level software may be specific to the type of hardware interface mechanism that exists between the host processor and the receiver hardware. For example, the driver level software may be different depending upon whether the hardware interface between the one or more processors in the host processor and the receiver hardware is interrupt driven, implemented with memory mapped address/registers or packet based transaction interface like SDIO. Some examples of tasks performed by the driver block 306 include hardware interactions such as initialization, sleep or wakeup triggers, data exchange with hardware such as emptying hardware buffers into main memory or providing ISR implementation, and MAC layer implementation to support inter-frame sleep logic functionality.

Generally, the driver block 306 functions are tightly coupled with the receiver hardware and are considered time sensitive in nature. Therefore, the driver block 306 may be given a higher priority with respect to other blocks shown in FIG. 3. For example, the driver block 306 may perform the tasks of retrieving the data received by the receiver hardware or instructing the receiver hardware to tune to a frequency as requested by the application layer.

The ASIC specific software block 308 provides the MAC layer functionality not handled by the driver block 306. Depending upon the division of MAC layer functionality across different blocks, it may provide complete or partial MAC layer functionality. At the very least, the ASIC specific software block 308 will generally provide high level MAC layer functionality that is not practical to be delegated to driver block 306.

The receiver stack block 312 communicates with the ASIC specific software block 308 using the API 310. The receiver stack block 312 implements the control and stream layers and provides the interface with the application layer protocols. The receiver stack block 312 triggers the ASIC specific software block 308 to receive the specified contents as requested by the application layer. The receiver stack block 312 acts on the notifications or content provided by the ASIC specific software block 308 and delivers any content received from the ASIC specific software block 308 to the application layer protocols.

The API 310 defines the interfaces that allows the ASIC specific software block 308 to communicate with the receiver stack block 312. Any receiver stack that adheres to the interfaces defined by the API 310 will work with any ASIC specific software that adheres to these interfaces as well. This interface will be presented in greater detail below.

The hardware interface block 305 represents the hardware interface mechanism that exists between the host processor block 304 and the receiver hardware block 302. This interface provides the communication and data exchange functionality. The driver block 306 uses this interface 305 to exchange commands and data with the receiver hardware block 302. The hardware interface block 305 can be any desired interface, such as a proprietary bus interface or a standard based interface (e.g. SDIO).

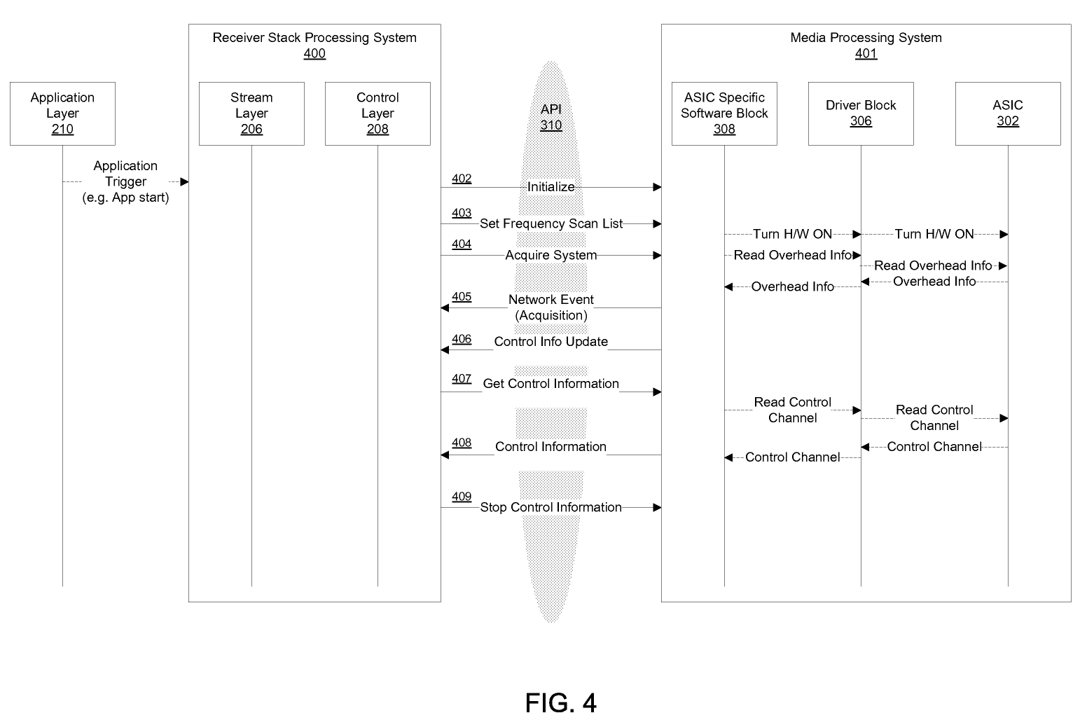

Various examples will now be presented illustrating the communication that takes place within the receiver 300 across the API 310. The following examples will be described in connection with FIGS. 4-11 containing call flows. In these figures, solid arrows indicate communication occurring over the API 310. The role played by the receiver blocks and communication occurring within the blocks in the receiver stack processing system 400 and media processing system 401 is presented for the sake of completeness only. As previously mentioned, the actual role played by individual receiver blocks and the communication between the blocks located in either of these processing systems (i.e., on same side of the API 310) is implementation dependent and can vary from one implementation to another. This communication is depicted as dashed arrows in the figures.

FIG. 4 is a diagram illustrating an example of the call flow to turn on the receiver. In step 402, an initialize command from the receiver stack processing system 400 is sent to the ASIC specific software block 308 to enable the receiver. This command can be sent as a result of some application layer trigger or on power-up. This command causes the ASIC specific software block 308 to perform any start up activities, such as turning on the hardware in preparation to perform various receiver functions.

In step 403, a command from the receiver stack processing system 400 is sent to the ASIC specific software block 308 specifying a set of frequencies (along with the bandwidth/channel plan) from which the receiver 300 selects a frequency to acquire the wireless signal. The set of frequencies and bandwidth may be retrieved from information provisioned at the wireless device.

In step 404, the receiver stack processing system 400 sends a command to the ASIC specific software block 308 to acquire the system. This command causes the ASIC specific software block 308 to read the overhead information on the selected frequency.

In step 405, a network event from the ASIC specific software block 308 is received by the receiver stack processing system 400 indicating that the overhead information has been acquired along with a network ID and the type of overhead information acquired (i.e., local-area or wide-area information). Once the overhead information has been acquired, the ASIC specific software block 308 sends, in step 406, a control information update message to the receiver stack processing system 400 indicating that control information is available along with the latest control information sequence numbers that have been received. In step 407, the receiver stack processing system 400 commands the ASIC specific software block 308 to get the control information. In response, the ASIC specific hardware block 308 reads the control channels and sends packets of control information, in step 408, to the receiver stack processing system 400 every frame. Included in each frame is side information which identifies the location of the control packet(s) in the frame and the sequence number of each packet. Once the receiver stack processing system 400 has determined that the control information has been received in its entirety, it instructs the ASIC specific software block 308 to stop receiving the control channel in step 409.

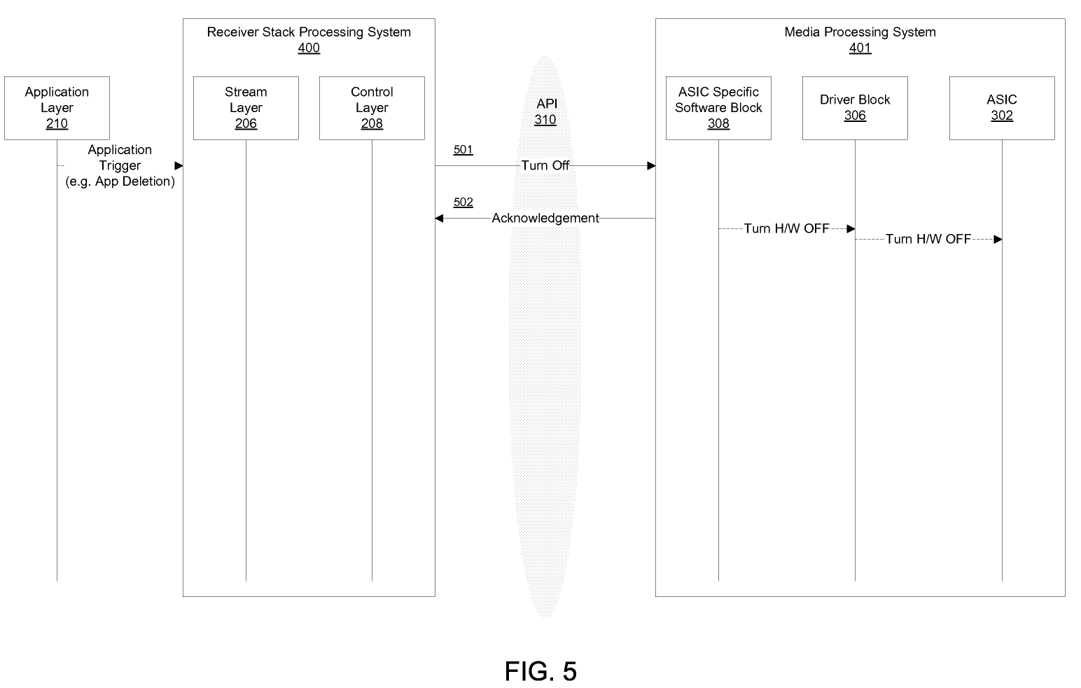

FIG. 5 is a diagram illustrating an example of the call flow to turn off the receiver. In step 501, a command from the receiver stack processing system 400 is sent to the ASIC specific software block 308 to turn off the receiver. This command causes the ASIC specific software block 308 to instruct the other blocks in the media processing system to turn off the receiver. In step 502, an acknowledgement is sent back to the receiver stack processing system 400 indicating that the command has been accepted.

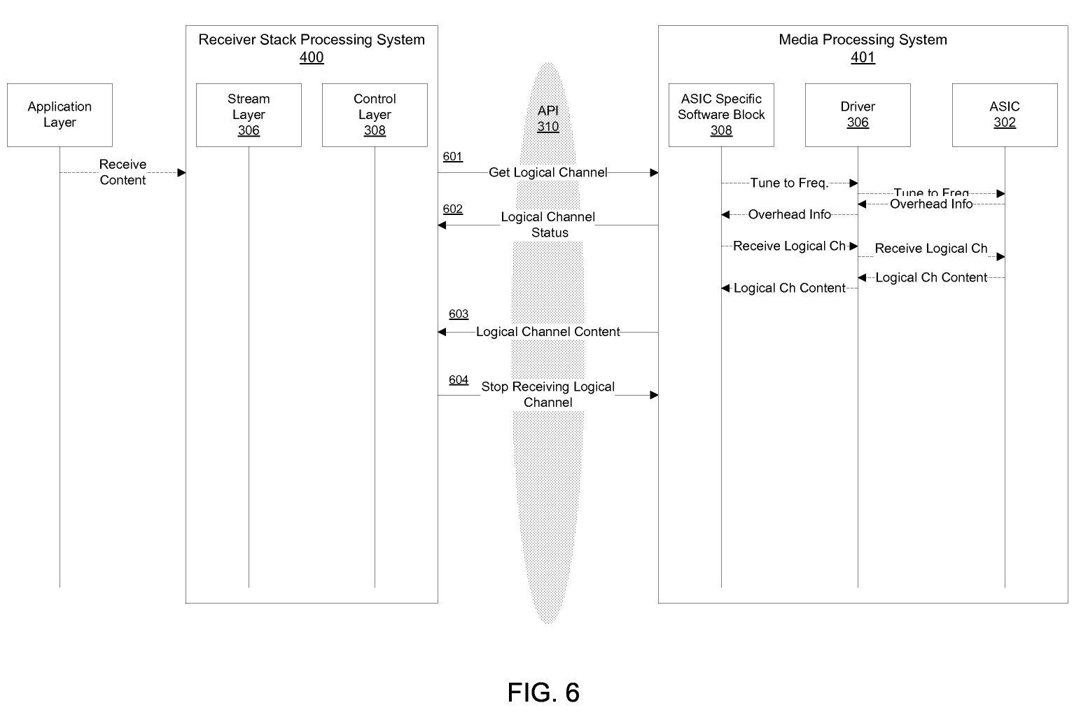

FIG. 6 is a diagram illustrating an example of the call flow when a specific logical channel is requested by the receiver stack processing system 400. This is usually caused by an application layer trigger to receive content for a specified flow. The control layer converts the flow ID into a mapped ID for the logical channel (along with the frequency on which that logical channel is being transmitted) so that the desired content can be received over the appropriate logical channel.

In step 601, the receiver stack processing system 400 commands the ASIC specific software block 308 to get the content on the specified logical channel ID. Along with the logical channel ID, the physical layer characteristics of logical channel are provided (e.g., frequency, transmit mode, outer code rate). Also, the sequence numbers for the control packets are provided for the ASIC specific software block 308. This allows the ASIC specific software block 308 to determine if the control information maintained by the control layer is current and if there is a need to receive the control channel prior to receiving the logical channel.

In step 602, the ASIC specific software 308 acknowledges whether or not it will be able to service the command to get the requested logical channel.

In step 603, the ASIC specific software block 308 returns the content on the logical channel retrieved from the receiver hardware block 302. The content on the logical channel is returned after the R-S decoding has been performed. The content is returned every frame until the receiver stack processing system 400 requests the ASIC specific software block 308 to stop receiving content on that logical channel in step 604.

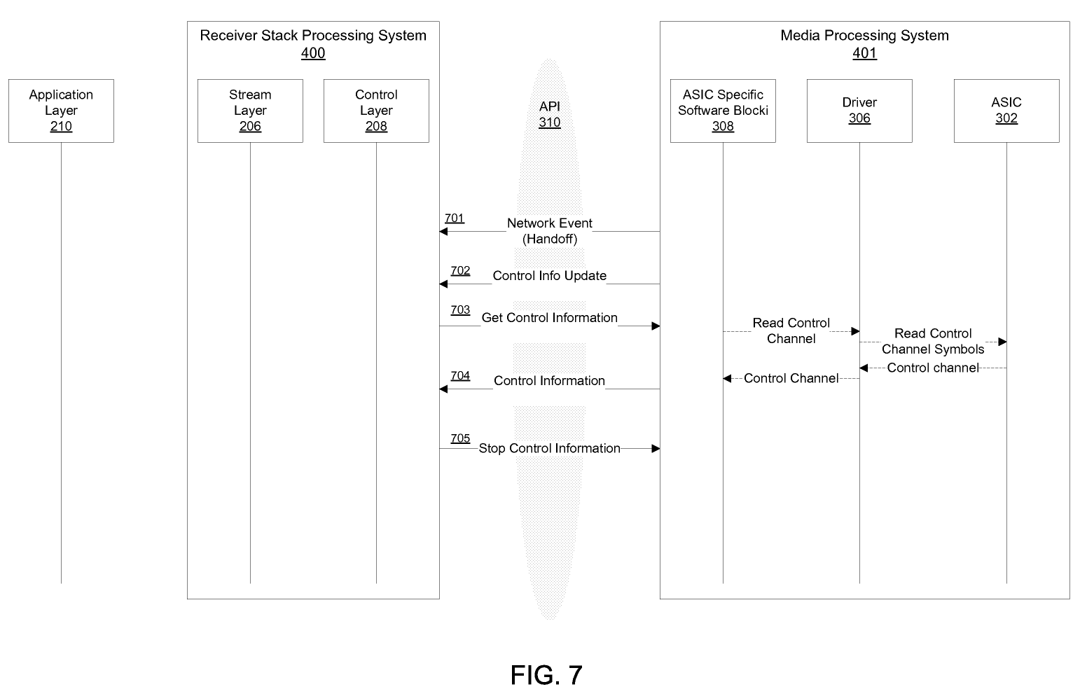

FIG. 7 is a diagram illustrating an example of the call flow when the device transitions from the coverage region of a network or infrastructure to another. In step 701, a transition is detected when a change in the network or infrastructure ID. The network or infrastructure ID may be included in a system parameters message included in the overhead portion of the frame. Upon detecting a change, the ASIC specific software block 308 sends to the receiver stack processing system 400 a network event indicating that a transition is about to occur. In one configuration of the receiver 300, the ASIC specific software block 308 implements a hysteresis algorithm before sending this indication to receiver stack processing system 400 to avoid toggling the network event multiple times as the wireless device roams along the border between two networks or infrastructures.

In step 702, the ASIC specific software block 308 sends a control information update message to the receiver stack processing system 400 indicating that updated control information is available along with the latest control sequence numbers received. In step 703, the receiver stack processing system 400 commands the ASIC specific software block 308 to get the control information for the new area that the wireless device has moved into. In response, the ASIC specific hardware block 308 reads the control channels and sends packets of control information, in step 704, to the receiver stack processing system 400 Included in each frame is side information which identifies the location of the control packet(s) in the frame and the sequence number of each packet. In step 705, the receiver stack processing system 400 determines that the control information has been received in its entirety and instructs the ASIC specific software block 308 to stop receiving the control channel.

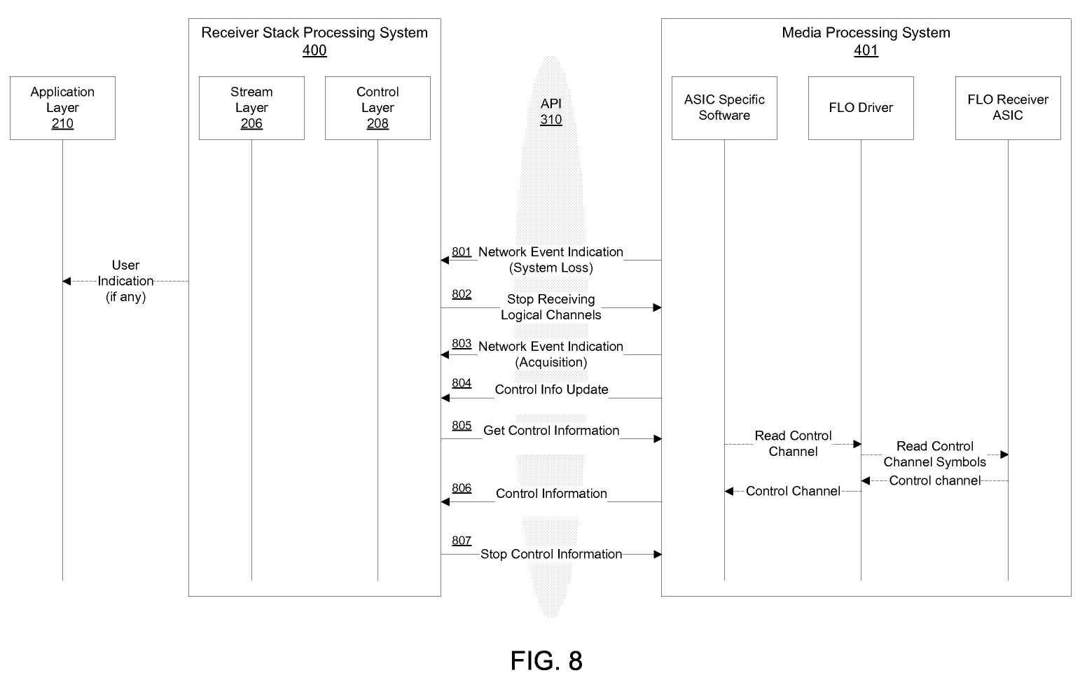

FIG. 8 is a diagram illustrating an example of the call flow when a receiver fails to meet the acquisition criteria such as persistent errors received on an overhead channel or on some or all the logical channels being currently received by the receiver. When the receiver fails to meet this criteria, in step 801, the ASIC specific software block 308 sends a network event indication to the receiver stack processing system 400. Upon receiving this indication, the receiver stack 312 simply waits for the acquisition of the same or another network. An optional user indication may be sent to the application layer indicating that the receiver failed meet to acquisition criteria.

In step 802, the receiver stack 312 sends a command to the ASIC specific software to abandon receiving data on the active logical channels and to free up any resources allocated towards receiving those logical channels.

Once a network is successfully acquired in step 803, the ASIC specific software block 308 sends a network event indication to receiver stack specifying the successful acquisition. If the acquired network is different from the last acquired network, or the control sequence numbers have been updated, the ASIC specific software block 308 sends a control information update message to the receiver stack processing system 400, in step 804, indicating that updated control information is available along with the latest control sequence numbers received. In step 805, the receiver stack processing system 400 commands the ASIC specific software block 308 to get the control information for the network that has been acquired. In response, the ASIC specific hardware block 308 reads the control channels and sends packets of control information, in step 806, to the receiver stack processing system 400 Included in each frame is side information which identifies the location of the control packet(s) in the frame and the sequence number of each packet. In step 807, the receiver stack processing system 400 determines that the control information has been received in its entirety and instructs the ASIC specific software block 308 to stop receiving the control channel.

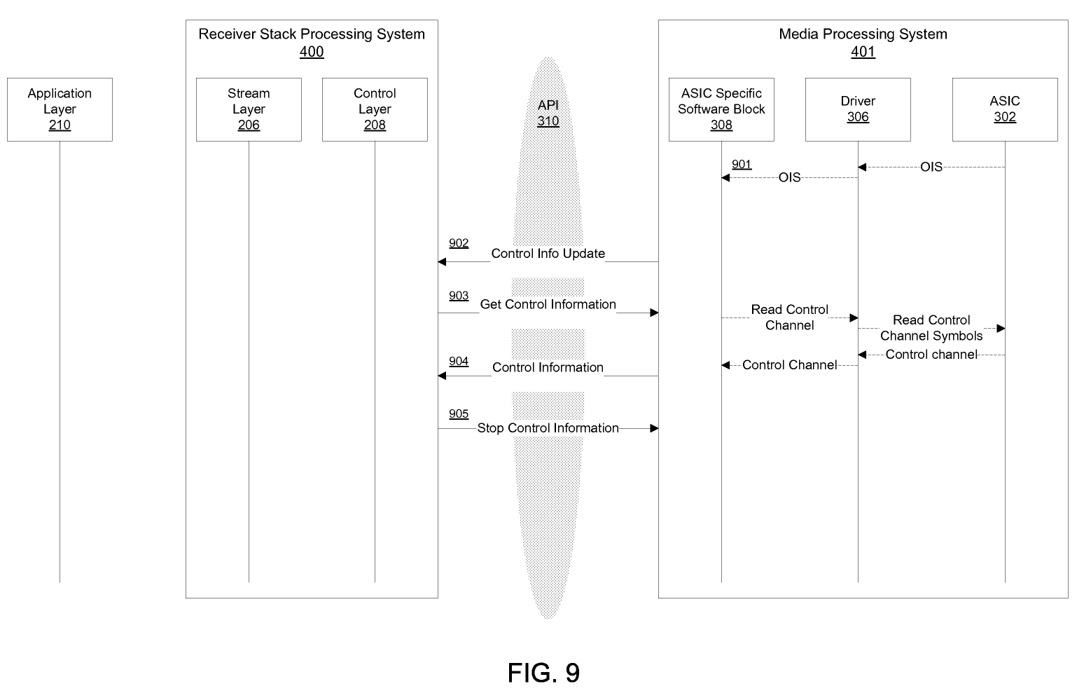

FIG. 9 is a diagram illustrating an example of the call flow when the receiver detects an update in the control information in its cache. The updated control information is detected by the ASIC specific software block 308 when the control sequence numbers received in the overhead channel are different than the last received.

When ASIC specific software block receives the overhead information in step 901, it compares the control sequence numbers received with the last stored. If there is an update detected, the ASIC specific software block 308 sends a control information update message to the receiver stack processing system 400, in step 902, indicating that an update in the control information is available. In step 903, the receiver stack processing system 400 commands the ASIC specific software block 308 to get the control information. In response, the ASIC specific hardware block 308 reads the control channels and sends packets of control information, in step 904, to the receiver stack processing system 400. Included in each frame is side information which identifies the location of the control packet(s) in the frame and the sequence number of each packet. In step 905, the receiver stack processing system 400 determines that the control information has been received in its entirety and instructs the ASIC specific software block 308 to stop receiving the control channel.

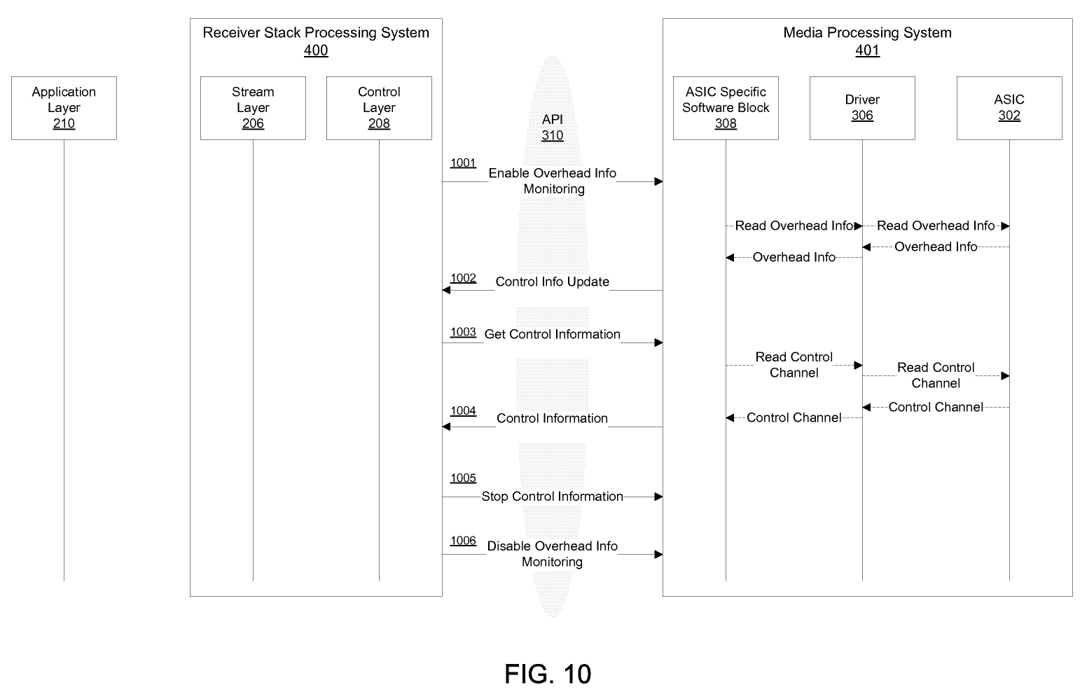

FIG. 10 is a diagram illustrating an example of the call flow to monitor the overhead information. The overhead information may be monitored with a given periodicity as specified by a in a system parameters message in the overhead portion of the frame. In the absence of any other event that requires the receiver to read the overhead information, it can read the overhead information at the specified interval.

In step 1001, the receiver stack processing system 400 commands the ASIC specific software to enable monitoring of the overhead information based on the periodicity defined by the system parameters message. The ASIC specific software block 308 ensures that overhead information is monitored with at least this periodicity in absence of any other event causing it to read the overhead information.

In step 1002, an update of the control information is detected by the ASIC specific software block 308 when the control sequence numbers received in the overhead information are different than the last received. The receiver stack 312 receives a control information update message from the ASIC specific software block 308 indicating that an update in the control information is available. In step 1003, the receiver stack processing system 400 commands the ASIC specific software block 308 to get the control information. In response, the ASIC specific hardware block 308 reads the control channels and sends packets of control information, in step 1004, to the receiver stack processing system 400. Included in each frame is side information which identifies the location of the control packet(s) in the frame and the sequence number of each packet. In step 1005, the receiver stack processing system 400 determines that the control information has been received in its entirety and instructs the ASIC specific software block 308 to stop receiving the control channel.

Upon being commanded to disable the periodic monitoring of the overhead information, the ASIC specific software block 308 disables it in step 1006. Steps 1002-1005 are conditional and are performed only when an update of control information is detected in the overhead information received.

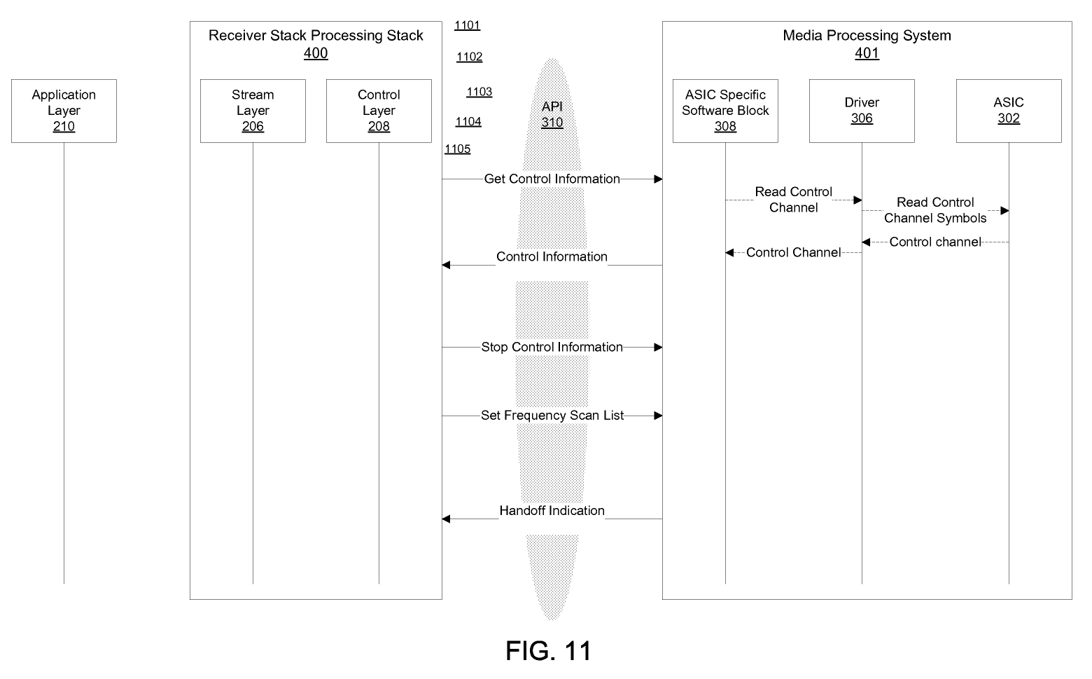

FIG. 11 is a diagram illustrating an example of the call flow of setting the frequency scan list for the ASIC specific software block 308. The frequency scan list is obtained from the neighborhood local-area information present in the control information. The ASIC specific software block 308 uses this scan list to implement handoff algorithms.

In step 1101, the receiver stack processing system 400 commands the ASIC specific software block 308 to get the control information. In response, the ASIC specific hardware block 308 reads the control channels and sends packets of control information, in step 1102, to the receiver stack processing system 400. Included in each frame is side information which identifies the location of the control packet(s) in the frame and the sequence number of each packet. In step 1103, the receiver stack processing system 400 determines that the control information has been received in its entirety and instructs the ASIC specific software block 308 to stop receiving the control channel.

In step 1104, the receiver stack processing system 400 makes a consolidated list of the neighboring systems by processing the neighborhood description message in the control information. The receiver stack processing system 400 then conveys this list to the ASIC specific software block 308. The ASIC specific software blocks 308 uses this list to execute handoff algorithms by using this list to monitor the signals from the neighboring systems. If a handoff to a neighboring system is performed, an indication is sent to the receiver stack processing system 400 in step 1105 along with wide-area and local area differentiators for the destination system. Step 1105 is conditional and performed only when the handoff is performed. After handoff, the new system is acquired and overhead information received on it is used to detect further network events.

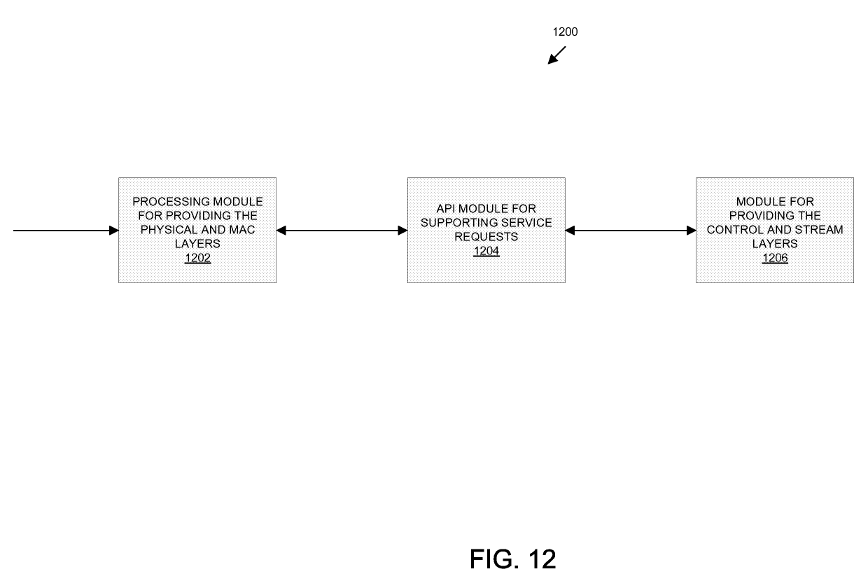

FIG. 12 is a functional block diagram of an apparatus configured to receive a signal in accordance with a protocol stack comprising a physical layer, MAC layer, control layer and stream layer. The apparatus 1200 may be a device 110 (see FIG. 1), or one or more entities within the apparatus. The apparatus 1200 includes a module 1202 for providing the physical and MAC layers, a module 1206 for providing the control and stream layers, and an API module 1204 for supporting service requests.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or moe.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus configured to receive a signal in accordance with a protocol stack comprising a physical layer, MAC layer, control layer and stream layer, comprising:
a receiver stack processing system configured to provide the control and stream layers;
a media processing system configured to provide the physical and MAC layers; and
an application programming interface (API) to support service requests from the receiver stack processing system to the media processing system.

2. The apparatus of claim 1 wherein the media processing system comprises an application specific integrated circuit (ASIC) and a host processor, the host processor having driver level software, ASIC specific software, and one or more processors configured execute the driver level software and ASIC specific software.

3. The apparatus of claim of 2 wherein the ASIC is configured to provide the physical layer.

4. The apparatus of claim 3 wherein the host processor is configured to provide the MAC layer.

5. The apparatus of claim 1 wherein the media processing system comprises an application specific integrated circuit (ASIC) and a host processor, the host processor having API software and one or more processors configured execute the API software.

6. The apparatus of claim 1 wherein the API comprises API software and one or more processors configured to execute the API software.

7. The apparatus of claim 1 wherein the service requests includes a request to turn on the media processing system.

8. The apparatus of claim 7 wherein the media processing system, in response to the service request to turn on the media processing system, is configured to tune to a selected frequency, retrieve overhead information from the signal, and provide control information to the receiver stack processing system processing system.

9. The apparatus of claim 1 wherein the service requests include a request to turn off the media processing system.

10. The apparatus of claim 1 wherein the service requests include a request to receive content on a specified logical channel.

11. The apparatus of claim 1 wherein the service requests include a request to handoff the apparatus from a first network to a second network.

12. The apparatus of claim 11 wherein the receiver stack processing system is configured to issue the service request to handoff the apparatus in response to a network event identifier by the media processing system.

13. The apparatus of claim 12 wherein the media processing system, in response to the service request to handoff the apparatus, is configured to provide control information to the receiver stack processing system.

14. The apparatus of claim 1 wherein the service requests include a request to abandon receiving content on a logical channel and free up resources allocated to receiving the content on the logical channel in response to a network event identifier from the media processing system, the network event identifier indicating a failed attempt to acquire a network.

15. The apparatus of claim 1 wherein the service requests include a request to update control information.

16. The apparatus of claim 15 wherein the receiver stack processing system is configured to issue the service request to update the control information in response to an indicator from the media processing system that updated control information is available.

17. The apparatus of claim 16 wherein the media processing system, in response to the service request to update the control information, is configured to provide the updated control information to the receiver stack processing system.

18. The apparatus of claim 1 wherein the service requests include a request to periodically monitor a control channel, the periodicity being defined by a message contained in overhead information from the signal.

19. The apparatus of claim 1 wherein the service requests include a request to monitor signals from neighboring networks for handoff based on a list of neighboring networks provided by the receiver stack processing system to the media processing system.

20. The apparatus of claim 19 wherein the receiver stack processing system is further configured to generate the list from control information provided to it from the media processing system.

21. The apparatus of claim 20 wherein the media processing system is further configured to provide an indication to the receiver stack processing system when the apparatus is handed off to one of the neighboring networks.

22. An apparatus configured to receive a signal in accordance with a protocol stack comprising a physical layer, MAC layer, control layer and stream layer, comprising:
first processing means for providing the control and stream layers;
second processing means for providing the physical and MAC layers; and
application programming interface (API) means for supporting service requests from the first processing means to the second processing means.

23. The apparatus of claim 22 wherein the second processing means comprises an application specific integrated circuit (ASIC) and a host processor, the host processor having driver level software, ASIC specific software, and one or more processors configured execute the driver level software and the ASIC specific software.

24. The apparatus of claim of 23 wherein the ASIC is configured to implement the physical layer.

25. The apparatus of claim 24 wherein the host processor is configured to implement the MAC layer.

26. The apparatus of claim 22 wherein the API means comprises API software and one or more processors configured execute the API software.

27. The apparatus of claim 22 wherein the second processing means comprises an application specific integrated circuit (ASIC) and a host processor, and wherein the first processing means comprises the host processor having a receiver software stack and one or more processors configured execute the receiver software stack.

28. The apparatus of claim 22 wherein the service requests includes a request to turn on the second processing means.

29. The apparatus of claim 28 wherein the second processing means, in response to the service request to turn on the second processing means, is configured to tune to a selected frequency, retrieve overhead information from the signal, and provide control information to the first processing means.

30. The apparatus of claim 22 wherein the service requests include a request to turn off the second processing means.

31. The apparatus of claim 22 wherein the service requests include a request to receive content on a specified logical channel.

32. The apparatus of claim 22 wherein the service requests include a request to handoff the apparatus from a first network to a second network.

33. The apparatus of claim 32 wherein the first processing means is configured to issue the service request to handoff the apparatus in response to a network event identifier from the second processing means.

34. The apparatus of claim 33 wherein the second processing means, in response to the service request to handoff the apparatus, is configured to provide control information to the first processing means.

35. The apparatus of claim 22 wherein the service requests include a request to abandon receiving content on a logical channel and free up resources allocated to receiving the content on the logical channel in response to a network event identifier from the second processing means, the network event identifier indicating a failed attempt to acquire a network.

36. The apparatus of claim 22 wherein the service requests include a request to update control information.

37. The apparatus of claim 36 wherein the first processing means is configured to issue the service request to update the control information in response to an indicator from the second processing means that updated control information is available.

38. The apparatus of claim 37 wherein the second processing means, in response to the service request to update the control information, is configured to provide the updated control information to the first processing means.

39. The apparatus of claim 22 wherein the service requests include a request to periodically monitor a control channel, the periodicity being defined by a message contained in overhead information from the signal.

40. The apparatus of claim 22 wherein the service requests include a request to monitor signals from neighboring networks for handoff based on a list of neighboring networks provided by the first processing to the second processing means.

41. The apparatus of claim 40 wherein the first processing means is configured to generate the list from control information provided to it from the second processing means.

42. The apparatus of claim 40 wherein the second processing means is configured to provide an indication to the first processing means when the apparatus is handed off to one of the neighboring networks.

43. A method of communications, comprising:
receiving a signal in accordance with a protocol stack comprising a physical layer, MAC layer, control layer and stream layer, the physical and MAC layers, the control and stream layers being implemented with a media processing system, and the control and stream layers being implement with a receiver stack processing system; and
supporting service requests with an application programming interface (API) from the receiver stack processing system to the media processing system.

44. The method of claim 43 wherein the service requests includes a request to turn on the media processing system.

45. The method of claim 44 further comprising, in response to the service request to turn on the media processing system, tuning to a selected frequency, retrieving overhead information from the signal, and providing control information from the media processing system to the receiver stack processing system.

46. The method of claim 43 wherein the service requests include a request to turn off the media processing system.

47. The method of claim 43 wherein the service requests include a request to receive content on a specified logical channel.

48. The method of claim 43 wherein the service requests include a request to perform a handoff from a first network to a second network.

49. The method of claim 48 further comprising providing a network event identifier from the media processing system to the receiver stack processing system, wherein the service request to perform a handoff is issued in response to the network event identifier.

50. The method of claim 49 further comprising, in response to the service request to perform a handoff, providing control information from the media processing system to the receiver stack processing system.

51. The method of claim 43 further comprising providing a network event identifier from the media processing system to the receiver stack processing system, wherein the service requests include a request to abandon receiving content on a logical channel and free up resources allocated to receiving the content on the logical channel in response to the network event identifier.

52. The method of claim 43 wherein the service requests include a request to update control information.

53. The method of claim 52 further comprising providing an indicator from the media processing system to the receiver stack processing system that updated control information is available, wherein the service request to update the control information is issued in response to the indicator.

54. The method of claim 53 further comprising, in response to the service request to update the control information, providing the updated control information from the media processing system to the receiver stack processing system.

55. The method of claim 43 wherein the service requests include a request to periodically monitor a control channel, the periodicity being defined by a message contained in overhead information from the signal.

56. The method of claim 43 further comprising providing a list of neighboring networks from the receiver stack processing system to the media processing system, wherein the service requests include a request to monitor signals from neighboring networks for handoff based on the list of neighboring.

57. The method of claim 56 further comprising providing control information from the media processing system to the receiver stack processing system, wherein the list of neighboring networks is generated by the receiver stack processing system from the control information.

58. The method of claim 56 further comprising providing an indication from the media processing system to the receiver stack processing system when a handoff is performed to one of the neighboring networks.

59. A machine-readable medium comprising instructions executable by one or more processors in an apparatus, the apparatus being configured to receive a signal in accordance with a protocol stack comprising a physical layer, MAC layer, control layer and stream layer, the physical and MAC layers being implemented with a media processing system, and the control and stream layers being implement with a receiver stack processing system, the instructions comprising:
a receiver stack code segment to implement the receiver stack processing system; and
an application programming interface (API) code segment to support service requests from the receiver stack processing system to the media processing system.

60. The machine-readable medium of claim 59 further comprising a media code segment to implement at least a portion of a media processing system.

61. The machine-readable medium of claim 60 wherein the media processing system further comprises an application specific integrated circuit (ASIC), and wherein the media code segment is configured to interface with the ASIC to implement the media processing system.

62. The machine-readable medium of claim 59 wherein the service requests includes a request to turn on the media processing system.

63. The machine-readable medium of claim 59 wherein the service requests include a request to turn off the second processing means.

64. The machine-readable medium of claim 59 wherein the service requests include a request to receive content on a specified logical channel.

65. The machine-readable medium of claim 59 wherein the service requests include a request to perform a handoff from a first network to a second network.

66. The machine-readable medium of claim 65 wherein the receiver stack code segment is configured to issue the service request to perform a handoff in response to a network event identifier from the media processing system.

67. The machine-readable medium of claim 66 wherein the receiver stack code segment, in response to the service request to perform a handoff, is configured to receive control information from the media processing system.

68. The machine-readable medium of claim 59 wherein the receiver stack code segment is configured to receive from the media processing system a network event identifier indicating a failed attempt to acquire a network, the service requests including a request to abandon receiving content on a logical channel and free up resources allocated to receiving the content on the logical channel in response to the network event identifier.

69. The machine-readable medium of claim 59 wherein the service requests include a request to update control information.

70. The machine-readable medium of claim 69 wherein the receiver stack code segment is configured an indicator from the media processing system that updated control information is available, the receiver stack code being further configured to issue the service request to update the control information in response to the indicator.

71. The machine-readable medium of claim 70 wherein the receiver stack code segment, in response to the service request to update the control information, is configured to receive the updated control information from the media processing system.

72. The machine-readable medium of claim 59 wherein the service requests include a request to periodically monitor a control channel, the periodicity being defined by a message contained in overhead information from the signal.

73. The machine-readable medium of claim 59 wherein the receiver stack code is configured to provide a list of neighboring networks to the media processing system, and wherein the service requests include a request to monitor signals from the neighboring networks for handoff based on the list of neighboring networks.

74. The machine-readable medium of claim 73 wherein the receiver stack code segment is further configured to generate the list from control information received from the media processing system.

75. The machine-readable medium of claim 73 wherein the receiver stack code segment is further configured to receive an indication from the media processing system a handed off is performed to one of the neighboring networks.
